(19) United States
(12) Patent Application Publication
(10) Pub. No.: US 2007/0003201 A1
(43) Pub. Date: Jan. 4, 2007

(54) HIGH EFFICIENCY LIGHT GUIDE

(75) Inventors: David S. Fredley, Tucson, AZ (US); Julio C. Castaneda, Coral Springs, FL (US); Stephen D. Hunt, Cooper City, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: Motorola, Inc., Schaumburg, IL (US)

(21) Appl. No.: 11/469,171

(22) Filed: Aug. 31, 2006

Related U.S. Application Data
(63) Continuation-in-part of application No. 10/806,992, filed on Mar. 23, 2004.

(51) Int. Cl. G02B 6/10

(52) U.S. Cl. 385/129

(57) ABSTRACT

The present invention includes a light guide system (200) and a method (300) for increasing the efficiency of light guide systems. The light guide system can include a light conduit (204) having non-luminescent light directing portions (210) that direct light to a display structure (208) in a non-random manner and a reflective material (206) coated on interior surfaces (220) of the light directing portions of the light conduit for immediately directing the light to the display structure. The reflective material can be coated on the interior surfaces without a boundary between the light conduit and the reflective material.

### CROSS REFERENCE TO RELATED APPLICATIONS

This application is a continuation-in-part of prior application Ser. No. 10/806,992, filed on Mar. 23, 2004.

### FIELD OF THE INVENTION

This invention relates to the field of display systems and more particularly to light guides for such systems.

### BACKGROUND

Electrical devices are made in a variety of forms from very simple devices, such as flashlights, to sophisticated electronic computers. Many of these devices have visual indicators so that the operator of the device can tell which operating mode the device is in at a glance. Two types of visual indicators have come to market prominence. These are liquid crystal displays (LCDs) and light source displays, including lamps and light emitting diodes (LEDs).

LEDs are widely used for lighting in all kinds of electrical appliances. Their advantages include small size, low power consumption and very long service life. Display systems typically use an internal illumination means. In a simple supplemental illumination system, one or more light sources are placed behind or in front of the display. One of the disadvantages of the simple supplemental illumination system is the creation of “hot spots.” Hot spots are areas of the display where the light intensity is considerably greater than in other areas. Hot spots result in poor display readability. To correct the problem of “hot spots” and to more evenly distribute the light coming from the light sources, a light guide may be positioned behind the LCD.

As with most electrical components, discrete LEDs are available in leaded and leadless forms. The leadless form is commonly referred to as surface mounted. Typically when the circuitry used by a device is of one technology, either leaded or leadless, the LEDs are chosen to have the same mounting technology to avoid an additional assembly step. Both forms of LEDs require different assembly techniques. Leaded LEDs typically don't sit flush with the circuit board they are mounted on, but rather use their leads as standoffs so that they may protrude through an opening in the housing of the device where the user can see the top portion of the LED. The longer the leads of the LED are, the greater the tendency for them to get bent during assembly, and consequently, the greater the need for alignment during assembly.

Systems using surface mount LEDs, while not susceptible to bent leads, have a different challenge of channeling the light from the LED to a point where the user can see it. The most common solution is the use of a light guide. A light guide is a transparent member which carries the light produced by the surface mounted LED to an opening in the housing of the device. Light produced by the LED is transmitted through the light guide to the outside where a user can see the signal. Although a light guide can channel illumination to the display device, some of the light intensity is lost during the transmission because the light travels in all directions.

To recapture some of the light that travels in other directions, reflective materials can be placed at appropriate positions to redirect some of this light toward the display device. For instance, FIG. 1 is a cross-sectional schematic illustrating an existing light guide arrangement which use reflective materials to redirect light. FIG. 1 shows a light source 102, a light guide 104, a reflective material 106, and a display structure 108. The light produced by the light source 102 is depicted as a dotted line with arrows indicating the direction of travel.

As some light travels away from the display structure 108, the reflective material 106 can redirect the light towards the display structure 108. Nevertheless, FIG. 1 illustrates the deficiencies in the existing arrangement of the light guide 104 and the reflective material 106. In the prior art arrangements, the reflective material 106 is typically a flat sheet of reflective material placed adjacent to the light guide 104. In some instances, the reflective material 106 is simply placed adjacent to the light guide 104, and in other instances expensive optical adhesives are used to attach the reflective material 106 to the light guide 104, In arrangements where the reflective material 106 is not attached to the light guide 104, the gap between the light guide 104 and the reflective material 106 can be substantial and non-uniform at portions of the light guide 104 which are bent and/or curved. In either arrangement, for light to be reflected by the reflective material 106, light must travel to the reflective material 106. During this travel in the existing arrangement, the light must exit the light guide 104, travel through the layer intermediate to the reflective material 106, be redirected by the reflective material 106, and re-enter the light guide 104. As the light guide 104 has a different index of refraction than the intermediate layer, which typically has an index of refraction of the adhesive or simply air, some light is scattered as indicated by the dotted line. Thus, some light intensity is lost during the travel due to conversion to heat and to refraction in accordance with Snell's Law.

Also note that having a higher degree of index mismatching will result in a higher degree of reflection at the interface of two materials. For example, an interface between air having an index of refraction of 1 and glass having an index of refraction of 1.5 typically results in an reflection condition of 4%, Well known techniques of anti-reflection (AR) or anti-glare can be achieved by imposing an intermediary layer having an index of refraction between 1 and 1.5 between the air and glass, which can significantly reduce such adverse reflection conditions.

Snell's Law
nᵢ*sine(⊖ᵢ)=nᵣ*sine(⊖ᵣ)
where ⊖ᵢ(“theta i”) angle of incidence
⊖ᵣ(“theta r”)=angle of refraction
nᵢ index of refraction of the incident medium
nᵣ index of refraction of the refractive medium

In other non-analogous fields, it is also known that layers of metals can be used for shielding from electromagnetic interference (EMI). One such process of producing an EMI shield is disclosed by Chomerics, a division of Parker Hannifin Corp. located at 77 Dragon Court, Woburn, Mass. 01888-4014. Chomerics discloses a process of metalizing a material at room temperatures, which is an improvement over prior art metalizing techniques that operated at extreme temperatures. Note, the Chomerics process includes preparing a substrate for metallization by scoring and scratching the substrate so that the metal being deposited can affix to the surface. Such scoring and scratching can adversely affect optical properties of the substrate.

### SUMMARY OF THE INVENTION

In one aspect of the invention, a light guide system is provided. The light guide system can include a light conduit having non-luminescent light directing portions that direct light to a display structure in a non-random manner. Non-luminescent can refer to a passive substance that may reflect light but does not actively give off light. In addition, non-random can refer to a substantially predetermined occurrence, direction or action. The light guide system can also include a reflective material coated on interior surfaces of the light directing portions of the light conduit for immediately directing the light to the display structure in which the reflective material is coated on the interior surfaces without a boundary between the light conduit and the reflective material. The reflective material can define a border of a volume through which light can travel and the index of refraction of the volume can be substantially constant. The index of refraction of the volume can be the index of refraction of the light conduit. As an example, the light can be immediately directed to the display structure at an angle of substantially ninety degrees.

In one embodiment, a light source can be optically coupled to the light conduit. The reflective material can also be a conformal coating and the reflective material can include one or more of tin, nickel, copper, zinc, aluminum, silver, gold, chromium, an alloy or a composite thereof. Also, the light conduit can be a transparent member, The light conduit can be part of an electronic device.

In another aspect of the invention, a light guide system is provided, which can include a light conduit having non-luminescent light directing portions that direct light to a display structure in a non-random manner and a conformal coating of a reflective material on interior surfaces of the light directing portions of the light conduit for immediately directing the light to the display structure. The reflective coating is coated on the interior surfaces without a boundary between the light conduit and the conformal coating. The coating can define a border of a volume through which light can travel and the index of refraction of the volume can be substantially constant. The index of refraction of the volume can be the index of refraction of the light conduit. Further, a light source can be optically coupled to the light conduit. Similar to the configuration described above, light can be immediately directed to the display structure at an angle of substantially ninety degrees.

In still another aspect of the invention, a method of increasing the efficiency of a light guide system is provided. The method can include the step of providing a light conduit having non-luminescent light directing portions that direct light to a display structure in a non-random manner. The method can also include the step of coating interior surfaces of the light directing portions of the light conduit with a reflective material without a boundary between the coating and the light conduit such that light from a light source is capable of being immediately directed to the display structure. The coating can conform to the shape of the light conduit. The coating step can include spraying reflective material.

The above features and advantages of the present invention will be better understood with reference to the following figures and detailed description. It should be appreciated that the particular devices and methods illustrating the present invention are exemplary only and not to be regarded as limitations of the present invention.

### BRIEF DESCRIPTION OF THE DRAWINGS

There are presently shown in the drawings embodiments which are presently preferred, it being understood, however, that the invention is not limited to the precise arrangements and instrumentalities shown.

FIG. 1 is a cross-sectional schematic illustrating the prior art.

FIG. 2 is a cross-sectional schematic in accordance with an example of the inventive arrangements.

FIG. 3 is a flow chart illustrating the steps of a method of increasing the efficiency of a light guide system.

FIG. 4 is another cross-sectional schematic in accordance with an example of the inventive arrangements.

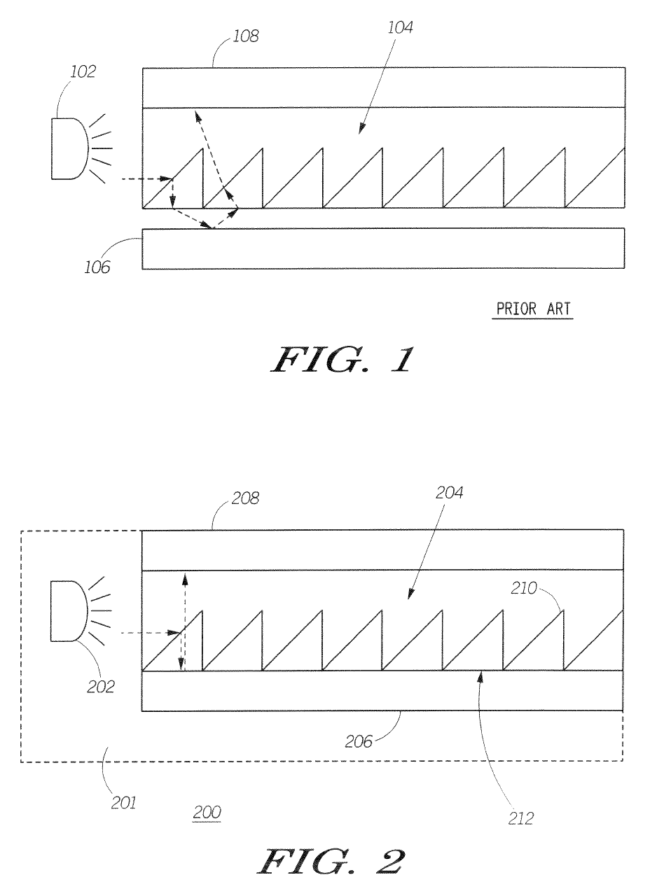

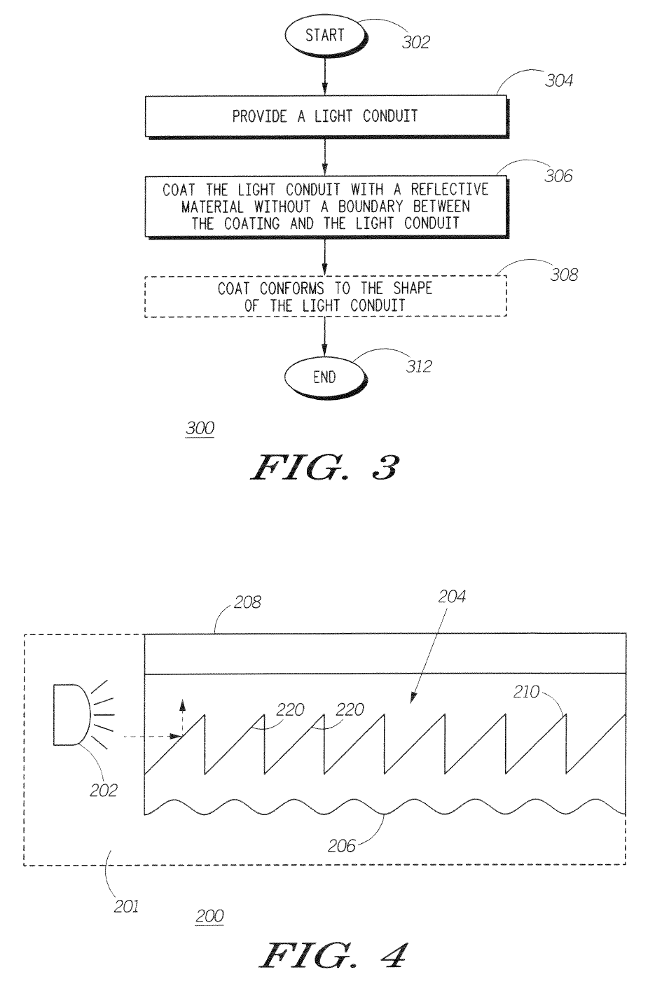

### DETAILED DESCRIPTION

Embodiments in accordance with the present invention demonstrate highly efficient light guide systems and a method for increasing the efficiency of a light guide system. The highly efficient light guide system can be used in conjunction with the current materials used for light guides. The light guide system eliminates the shortfalls of the prior art without adding significant size, weight, or cost to current light guides. Accordingly, the light guide system and method can be used with a variety of applications in which light guides are used, such as the display devices of cell phones, personal digital assistances, portable computing devices, watches, and so forth.

In accordance with the inventive arrangements, a light guide system 200 is illustrated in a cross-sectional schematic of FIG. 2. The light guide system 200 can include a light source 202, a light conduit 204 for directing light, a reflective material 206, and a display structure 208. The light source 202 can be optically coupled to the light conduit 204, which in turn, can be optically coupled to the display structure 208 for channeling light from the light source 202 to the display structure 208. As used herein. “optically coupled” means coupled or connected in an arrangement such that light can be transmitted from one location to another. As also used herein, the term “light” refers to electromagnetic radiation within or even outside of the visible light spectrum.

The light source 202 can be any light source that emits, at least, light within the visible light spectrum. A non-exhaustive list of light sources 202 includes one or more LEDs, incandescent bulbs, cold cathode lamps, monochromatic sources such as lasers, organic light emitting diodes (OLED), transparent OLED's (TOLED), phosphorescent OLED's (PHOLED), stacked OLED technologies (SOLED) or any other appropriate source. The invention is not limited to a specific type of light source 202 as any appropriate light source 202 can be used.

The display structure 208 can use light from the light source 202 to display information to a user, or to simply illuminate the display structure 208. In one example, the display structure 208 can be the display device for an electronic product 201 such as a cellular phone. A non-exhaustive list of display structures 208 can include an LCD, electrochromics, polymer-dispersed liquid crystals (PDLCs), or other passive light shuttering devices. It should be noted that the invention is not limited to any particular display structure 208 and that any suitable display structure 208 can be used.

The light conduit 204 can channel light from the light source 202 to the display structure 208. The light conduit 204 can be constructed of any appropriate material that is known in the art and can be transparent for optimal transmission of light. A non-exhaustive list of such materials can include transparent polymers, glass, and/or plastics. The light conduit 204 is not limited in shape as the light conduit 204 can include flat, bent, curved, and angled portions. Additionally, the light conduit 204 can include light directing portions 210 that can be arranged at particular angles for directing the light in a particular direction. The light directing portions 210 can be substantially pyramidally shaped; however, such an arrangement is not necessary as the light direction portions 210 can include other shapes and sizes. Note that the light conduit can also include microstructures such as microwedges within the material used for the light conduit.

A reflective material 206 can be coated to the light conduit 204 for reflecting light towards the display structure 208 or for further channeling along the light conduit 204. As an example, the reflective material 206 can be coated to a surface 212 of the light conduit 204. Nevertheless, the reflective material 206 can be coated to any appropriate surface of the light conduit 204. The surface 212 can be a substantially planar surface, although various shapes, designs, or geometries can be employed.

For purposes of the invention, coating can mean applying at least a portion of a layer of reflective material 206 to the light conduit 204. The reflective material 206 can be applied to the light conduit 204 with any suitable process where reflective material 206 can be coated to the light conduit 204 without a boundary between the light conduit 204 and the reflective material 206. For example, one such process includes the ECOPLATE™ coating process used by Chomerics of 77 Dragon Court, Woburn, Mass. 01888-4014. Other examples of suitable processes of coating can include curing, spraying, plating, painting, sputtering, electroplating, chemical plating, Zinc arc spraying, thermal evaporation, cathode sputtering, ion plating, electron beam, cathodic-arc, vacuum thermal spraying, vacuum metallization, electroless plating, vacuum plating, and the like or variations thereof. For instance, coating can include spraying atomized, heated, and/or powdered reflective materials 206 on the light conduit 204. It is understood, however, that the invention is not limited to the above examples as any other suitable process can be used to coat the reflective material 206 to the light conduit 204. Further, it should also be understood that a substantially clear material, or a material with an index of refraction that substantially matches the index of refraction of the light conduit 204, can be applied to promote the coating process such that no appreciable boundary exists between the light conduit and the reflective material.

The reflective material 206 can include any material capable of reflecting light. A non-exhaustive list of such materials includes tin, nickel, copper, zinc, aluminum, silver, gold, chromium, and alloys and composites thereof. Additionally, it should be noted that different reflective materials 206 can be coated to different portions of the light conduit 204 to suit the particular needs of those portions of the light conduit 204.

In contrast to the prior art, the reflective material 206 can be coated to the light conduit 204 without a boundary between the light conduit 204 and the reflective material 206. Such an arrangement is quite advantageous in comparison to the prior art as the light will not travel through a different medium with a different index of refraction in order to be reflected. Accordingly, such an arrangement greatly increases the efficiency of the light conduit 204.

Additionally, the reflective material 206 can form a conformal coating on the light guide 204. A conformal coating conforms to the contours of the light conduit 204 which is not possible in some of the prior art arrangements, such as the use of a sheet of reflective foil. For example, a conformal coating can be continuous and directly coated with the light conduit 204, even when the surface of the light conduit 204 varies with bends, corners, and/or recesses. Accordingly, a conformal coating does not leave any voids, gaps, or boundaries between the light conduit 204 and the reflective material 206 and can be considered united with the light conduit 204.

In such an arrangement, the reflective material 206 can define a border of a volume or pathway through which light can travel. This volume can be substantially the volume of the light conduit 204, and therefore, the index of refraction of the volume will essentially be the index of refraction of the light conduit 204. In some arrangements, the index of refraction will be constant; however, such an arrangement is not necessary as some portions of the light conduit 204 can have a different index of refraction relative to the adjacent portions.

Further, it should be noted, that the reflective material 206 can be coated to the light conduit 204 without first treating the light conduit 204 to produce a roughened surface for increased adhesion. Such preparation can produce scratches that can adversely affect or alter the optical properties of the light conduit 204. Accordingly, it is generally recommended to avoid scratching or abrading the surface of the light conduit 204 before coating with the reflective material 206. Some minor uniform scratching or abrading may still be acceptable for the purposes described herein. For example, scratches and/or abrasions that have a length less then the wavelength of the light transmitted through the conduit 204 may be applied to the surface 212 of the light conduit 204 which is coated.

In another aspect of the invention, a method 300 of increasing the efficiency of a light guide system is provided. The method 300 can include the following steps which can be completed in any particular order. Further, it should be noted that some of the steps can be omitted and that other steps not expressly mentioned can be completed without departing from the method 300.

Method 300 can proceed at step 304 by providing a light conduit. The light conduit can vary in size, shape, materials, or a combination thereof depending upon the application of the light conduit. For instance, a light conduit can be provided having planar surfaces for insertion within a cellular phone where compact configurations are necessary. Nevertheless, it should be noted that the invention can be used with any particularly sized and/or shaped light conduit including three-dimensional rectangles.

At step 306, the light conduit can be coated with a reflective material without a boundary between the coating and the light conduit. Coated the light conduit can include any of the processes mentioned above in which the optical properties of the light conduit are not significantly or adversely damaged or altered. It should be noted that coating the light conduit can occur at ambient temperatures at which the light conduit, and its optical properties, are not damaged.

In one example of coating the light conduit, reflective material can be optionally sprayed on the light conduit. Such spraying may include the use of atomized, heated, and/or powdered reflective materials. In this regard, at step 308, the coating can conform to the shape of the light conduit. As the reflective material is sprayed on the light conduit, the reflective material can form a coating which conforms to the shape of the light conduit so that no gaps or voids are left between the light conduit and the reflective material. The coating of the reflective material without a boundary between the reflective material and the volume of the light conduit can increase the efficiency of the intensity of light reflected. Alternatively, any of the steps of the method 300 can be completed again and in any order.

Referring to FIG. 4, another example of the light guide system 200 is shown. In this arrangement, the light directing portions 210 can be substantially hollow, and the reflective material 206 can be directly coated on an interior surface 220 of the light directing portions 210. Because the reflective material 206 is coated on the interior surfaces 220 of the light directing portions 210, the process of redirecting the light can be kept to a minimum. An example of the path that the light from the light source 202 to the display structure 208 may take in this arrangement is represented by the arrows. In view of this configuration, at least a portion of the light striking the light directing portions 210 can be immediately directed to the display structure 208. This can mean that at least some of the light can be directed to the display structure 208 by being reflected off of only one surface.

This invention can be embodied in other forms without departing from the spirit or essential attributes thereof. Although suitable methods and materials have been described above, methods and materials similar or equivalent to those described herein can be used in the practice or testing of the present invention. All publications, patent applications, patents, and other references mentioned herein are incorporated by reference in their entirety. In the case of conflict, the present specification, including definitions will control. Reference should be made to the following claims, rather than to the foregoing specification, as indicating the scope of the invention.

What is claimed is:

1. A light guide system, comprising:
a light conduit having non-luminescent light directing portions that direct light to a display structure in a non-random manner;
a reflective material coated on interior surfaces of the light directing portions of the light conduit for immediately directing the light to the display structure, wherein the reflective material is coated on the interior surfaces without a boundary between the light conduit and the reflective material.

2. The system according to claim 1, wherein the reflective material defines a border of a volume through which light can travel and the index of refraction of the volume is substantially constant.

3. The system according to claim 2, wherein the index of refraction of the volume is the index of refraction of the light conduit.

4. The system according to claim 1, further including a light source optically coupled to the light conduit.

5. The system according to claim 1, wherein the light is immediately directed to the display structure at an angle of substantially ninety degrees.

6. The system according to claim 1, wherein the reflective material is a conformal coating.

7. The system according to claim 1, wherein the reflective material includes at least one of tin, nickel, copper, zinc, aluminum, silver, gold, chromium, an alloy or a composite thereof.

8. The system according to claim 1, wherein the light conduit is a transparent member.

9. The system according to claim 1, wherein the light conduit is part of an electronic device.

10. A light guide system, comprising:
a light conduit having non-luminescent light directing portions that direct light to a display structure in a non-random manner; and
a conformal coating of a reflective material on interior surfaces of the light directing portions of the light conduit for immediately directing the light to the display structure, wherein the reflective coating is coated on the interior surfaces without a boundary between the light conduit and the conformal coating.

11. The system according to claim 10, wherein the conformal coating defines a border of a volume through which light can travel and the index of refraction of the volume is substantially constant.

12. The system according to claim 11, wherein the index of refraction of the volume is the index of refraction of the light conduit.

13. The system according to claim 10, further including a light source optically coupled to the light conduit.

14. The system according to claim 10, wherein the light is immediately directed to the display structure at an angle of substantially ninety degrees.

15. A method of increasing the efficiency of a light guide system, comprising:
providing a light conduit having non-luminescent light directing portions that direct light to a display structure in a non-random manner; and
coating interior surfaces of the light directing portions of the light conduit with a reflective material without a boundary between the coating and the light conduit such that light from a light source is capable of being immediately directed to the display structure.

16. The method according to claim 15, wherein the coating conforms to the shape of the light conduit.

17. The method according to claim 15, wherein the coating step includes spraying reflective material.

18. The method according to claim 15, wherein the coating step includes applying reflective material selected among the group comprising tin, nickel, copper, zinc, aluminum, silver, gold, chromium, an alloy or a composite thereof.
